(19) United States
(12) Patent Application Publication
(10) Pub. No.: US 2020/0390142 A1
(43) Pub. Date: Dec. 17, 2020

(54) EXTRUDED READY TO CONSUME FOOD PRODUCT

(71) Applicant: THE MUSHROOM BENEFIT LTD, NATANYA (IL)

(72) Inventors: MARILYN WEIGENSBERG, TEKOA (IL); Aharon BAR-TUR, TEL AVIV (IL); OREN KESSLER, TEKOA (IL); Harold KRUGER, HADAR AM (IL); Arturo GEIFMAN, HOD HASHARON (IL); Tal LEIZER, Zikhron Ya'akov (IL)

(73) Assignee: THE MUSHROOM BENEFIT LTD, NATANYA (IL)

(21) Appl. No.: 16/900,933

(22) Filed: Jun. 14, 2020

(30) Foreign Application Priority Data
Jun. 13, 2019 (IL) 267350

(51) Int. Cl. A23P 30/25; A23L 31/00; A23L 27/00; A23L 7/10

(52) U.S. Cl. CPC A23P 30/25; A23L 7/10; A23L 27/88; A23L 31/00

(57) ABSTRACT

The invention provides extruded ready to consume food products comprising: corn and at least one of grain and dry edible mushroom, including processes for their preparation.

### CROSS-REFERENCE TO RELATED APPLICATIONS

This application is claiming priority from IL Patent Application No. 267350, filed Jun. 13, 2019, which is hereby incorporated by reference.

### BACKGROUND OF THE INVENTION

Convenience food, or processed food, is food that is commercially prepared (often through processing) to optimize ease of consumption. Such food is usually ready to eat without further preparation. It may also be easily portable, have a long shelf life, or offer a combination of such convenient traits. Convenience foods include ready-to-eat dry products, shelf-stable foods, prepared mixes such as cake mix, and snack foods, breakfast cereal and so forth.

The primary effect of snacking is to alleviate hunger between meals, supplement meals or complement meals. Mindful or conscious snacking—when eating a nutritious and balanced snack—boosts the intake of essential nutrients healthful dietary elements such as fiber, protein, a degree of non-trans fat and other beneficial supplements while capping the daily intake of unnecessary and even harmful ingredients. Careless or reckless snacking, on the other hand, can easily exceed daily energy requirements while providing little to no nutritional benefit and this may contribute to the development of a range of health problems, including weight gain and diabetes, high cholesterol and blood pressure levels leading to heart disease and coronary failure, tooth decay and so forth.

Since many extruded snacks are primarily based on various forms of corn or fried substrates with unhealthy additives like salt, sugar, fat and artificial colors and flavors, a need exists for a healthier and more nutritious snack and extruded ready to consume food products that is ready to eat out of the packet with a reasonably long shelf life.

### SUMMARY OF THE INVENTION

The invention provides an extruded ready to consume food product comprising: corn and at least one of grain and dry edible mushroom.

When referring to a “ready to consume food product” in the present context of the invention, it should be understood to encompass an edible food product that typically does not need any preparation (such as for example cooking, baking, drying, or frying) before its consumption and can be immediately eaten by a subject. Said ready to consume food product of the invention can come in any shape or form and can be packaged (individually or in quantity) for immediate consumption. In some embodiments said ready to consume food product can be consumed in a dry form. In other embodiments, said ready to consume food product of the invention can be consume with an addition of an additive, such as milk, milk substitutes, yogurt, porridge, water, juice and so forth. In some embodiments said ready to consume food product is selected from a snack, breakfast cereal, breakfast meal, supplemental food product, bar, between-meal snack, and so forth. The ready to consume food product of the invention is considered processed food, which is made by an extrusion process (thus the term “extruded ready to consume food product”).

Food extrusion is a process by which a predetermined mixture of ingredients are fed into a tapered, rotating screw auger contained in a barrel that compresses the material into a homogenous mass that is forced through an opening in a perforated plate or die with a restricted cross-sectional shape that gives the desired form to the extruded product, which then enters a knife assembly containing two, four or six blades, and is cut into a specific size and shape by blades. The barrel containing the screw auger and the die is an extruder, and the mix is known as the extrudate. The extruder consists of the feed, the barrel containing the screw auger(s) (in some embodiments the extruded is a single screw extruder and in other embodiments the extruder is a dual screw extruder), the die and the knife assembly. Extrusion enables mass production of food via a continuous, efficient system that ensures uniformity and stability of the final product.

When referring to a “dried edible mushroom” it should be understood to encompass any type of edible mushroom (and any combination thereof) having nutritional (typically containing riboflavin, niacin, and pantothenic acid, proteins, minerals like zinc, magnesium, manganese and phosphorus) and culinary value and include many fungal species that are either harvested in the wild or commercially cultivated. In some embodiments, the dried mushroom of the invention is dehydrated/desiccated to reduce the level of moisture (water content) within its fibers to less than 15%. In some embodiments, the dried mushroom of the invention is dehydrated/desiccated to reduce the level of moisture within its fibers to less than 0.6 Water activity (aW).

In some embodiments, said edible dried mushroom is selected from shiitake mushroom, champignon mushroom, porcini mushroom, black trumpet mushroom, morel mushroom, matsutake mushroom, maiitake mushroom, chanterelle mushroom, turkey tail mushroom, lion's mane mushroom, Agricus blazei murrill mushroom, lobster mushroom, oyster mushroom, king oyster mushroom, truffle and any combinations thereof.

In further embodiments, before being extruded into the ready to consume food product of the invention, said edible mushroom is sliced, kibbled, crushed, ground, shredded, chopped and any combinations thereof.

When referring to “corn” it should be understood to encompass the kernels of any variety of corn, in any form including syrup, dried kernels, flakes, flour, unprocessed kernels, cooked corn, raw corn and any combination thereof.

When referring to “grain” it should be understood to encompass any small, hard, dry seed, with or without an attached hull or fruit layer, harvested for human or animal consumption. A grain crop is a grain-producing plant. In some embodiments, said grain is selected from legume, cereal grain, pseudo-grain, pulses, oilseed and any combinations thereof In some embodiments said grain is a legume. In other embodiments said grain is a cereal grain. In other embodiments said grain is a pseudo-grain. In other embodiments said grain is pulses. In other embodiments said grain is an oil seed.

In some embodiments said cereal is selected from millet, barley, oats, rice, rye, spelt, teff, triticale, wheat, rice and any combinations thereof.

When referring to “legume” it should be understood to encompass the plant in the family Fabaceae (or Leguminosae), or the fruit or seed of such a plant (also called a pulse). In some embodiments said legume is selected form alfalfa, clover, bean, pea, chickpea, lentil, lupin, mesquite, carob, soybean, tamarind and any combinations thereof

In some embodiments, said grain is rice. In other embodiments, said grain is chickpeas. In some embodiments, said grain is oats.

When referring to “oats” it should be understood to encompass the seed of the common species of cereal grain, including the groats, the cereal germ, fiber-rich bran, the endosperm, any single component thereof and any combination thereof. Oats are a nutrient-rich food associated with lower levels of heart disease as part of a diet low in saturated fat and cholesterol when consumed regularly.

Before being extruded to the ready to consume food product of the invention, said oats content may be in any processing form including oatmeal, rolled oats, oat flakes, oat bran mill, oat flour, raw oats, cooked oats, oatrim and any combination thereof.

In some embodiments, an extruded ready to consume food product of the invention comprises oats and dry edible mushroom. In some embodiments, an extruded ready to consume food product of the invention comprises legume and dry edible mushroom. In some embodiments, an extruded ready to consume food product of the invention comprises grain and dry edible mushroom. In some embodiments, an extruded ready to consume food product of the invention comprises legume, grain and dry edible mushroom.

In other embodiments, said extruded ready to consume food product of the invention comprises oats. In further embodiments, said extruded ready to consume food product of the invention comprises dry edible mushroom.

In some embodiments, said corn is no more than 90% wt of the ready to consume food product. In some embodiments, said corn is no more than 80% wt of the ready to consume food product. In some embodiments, said corn is no more than 60% wt of the ready to consume food product. In some embodiments, said corn is no more than 50% wt of the ready to consume food product.

In some embodiments, said grain (in some embodiments oats) is at least 15% wt of the ready to consume food product. In other embodiments, said grain (in some embodiments oats) is at least 25% wt of the ready to consume food product. In further embodiments, said grain (in some embodiments oats) is between about 15% to 50% wt of the ready to consume food product. In further embodiments, said grain (in some embodiments oats) is about 15%, 20%, 25%, 30%, 35%, 40%, 45%, 50% wt of the ready to consume food product.

In some embodiments, said dry edible mushroom is at least 10% wt of the ready to consume food product. In some embodiments, said dry edible mushroom is at least 15% wt of the ready to consume food product. In some embodiments, said dry edible mushroom is between about 10% to 50% wt of the ready to consume food product. In some embodiments, said dry edible mushroom is about 10%, 15%, 20%, 25%, 30%, 35%, 40%, 45%, 50% wt of the ready to consume food product.

In some embodiments, said extruded ready to consume food product of the invention further comprises starch. In further embodiments, starch is no more than 4% wt of the ready to consume food product. In some embodiments, said starch is plant-based. In further embodiments, said plant-based starch is selected from tapioca starch, corn starch, wheat starch, potato starch, rice starch, yuca starch and any combination thereof In some embodiments, starch is between 1% to 4% wt of the ready to consume food product. In some embodiments, starch is about 1.0%., 1.5%, 2.0%, 2.5%, 3.0%, 3.5%, 4.0% wt of the ready to consume food product.

In some embodiments, said extruded ready to consume food product of the invention further comprises at least one flavoring agent. In some embodiments said at least one flavoring agent is coated on the outer surface of said extruded ready to consume food product. In some embodiments said coating is achieved by oil spraying of said at least one flavoring agent. In other embodiments, said at least one flavoring agent is electronically coated (or sprayed) on said extruded ready to consume food product. In some embodiments, said at least one flavoring agent is added to said extruded food product before and/or during the extrusion process.

When referring to “flavoring agent” it should be understood to encompass any type of substance that gives another substance flavor, in any form including aqueous solution, oily solution, dry flakes/particles/crystals, dry powder, and any combination thereof. The terms flavoring and flavorant denote the combined chemical sensations of taste and smell, the same terms are also used in the fragrance and flavors industry to refer to edible chemicals and extracts that alter the flavor of food and food products through the sense of smell. In the contents of the present invention, said at least one flavoring agent relates to agents other than salt, sugar, pepper or vinegar as a standalone agent or any combinations thereof. Flavorants such as salt, sugar, pepper or vinegar can each be further added to the at least one supplemental flavoring agent.

In some embodiments. said corn is no more than (i.e. up to) 90% wt of the ready to consume food product. In some embodiments. said corn is no more than 80% wt of the ready to consume food product. In some embodiments. said corn is no more than 70% wt of the ready to consume food product. In some embodiments. said corn is no more than 60% wt of the ready to consume food product. In other embodiments, said corn is no more than 20% wt of the ready to consume food product. In further embodiments, corn is no more than 10% wt of the ready to consume food product. In yet other embodiments, corn is between about 10% to 90% wt of the ready to consume food product. In other embodiments, corn is about 10%, 15%, 20%, 25%, 30%, 35%, 40%, 45%, 50%, 55%, 60%, 65%, 70% 75%, 80%, 85%, 90% wt of the ready to consume food product.

In some embodiments, said starch is no more than (i.e. up to) 4% wt of the ready to consume food product. In further embodiments, said starch is between 1% to 4% wt of the ready to consume food product. In further embodiments, said starch is 1.0%, 1.5%, 2%, 2.5%, 3%, 3.5%, 4% wt of the ready to consume food product.

In a further aspect the invention provides a process for the preparation of an extruded ready to consume food product; said process comprises (i) preparing a mixture comprising corn and at least one of oats and dry edible mushroom; (ii) processing said mixture in an extruder thereby forming an extruded product; (iii) drying said extruded product; (iv) optionally coating dried extruded product with at least one of oil and flavoring agent (s); thereby forming said extruded ready to consume food product. In some embodiments, said mixture further comprises liquids such as water and/or vegetable oil. In some embodiments, said mixture further comprises starch. In other embodiments, said extruder is a single screw extruder. In other embodiments, said extruder is a double screw extruder. In yet further embodiments, said processing of the mixture in an extruder is performed using a dosing feeder. In some embodiments said dosing feeder feeds said mixture to the extruder in a speed of 50-100 kg/h. In some other embodiments, drying of said extruded product is performed using a drying belt. In some further embodiments, said drying is performed using heat of between about 100 to 200 C. In some embodiments, said mixture comprises at least 10% of dry edible mushroom of the mixture. In some embodiments, said mixture comprises between 10 to 50% of dry edible mushroom of the mixture. In other embodiments, said mixture comprises at least 10% corn of the mixture. In other embodiments, said mixture comprises between 10% to 80% corn of the mixture.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Single screw extruder procedure:

Extruder is equipped with a single screw with a variable pitch of 350 mm inside the barrel, with variable pacing reversed between them and driven by a motor for variable speed between 150-300 rpm at the end installed matrix with different shapes of holes

Between 4.5 and 5.5 mm on the matrix a heating element is installed to warm the matrix before starting to work to a temperature of 140-170 degrees Celsius pressure created during the work reaches 100-150 bar, outputs ranging between 60-100 kg. A cutting system is installed on the front of the matrix by 2-4 lice that can be adjusted according to product size.

The mixture is fed into the extruder with a double feeder that filters the mixture on demand and creates pressure on the motor and the matrix to produce a controlled exit of the product through the matrix and cut it to the right size according to our product specifications. Once the mixture exits the matrix, a pressure equalizer within the extruder is functioned defining the size of the product and its inflation/puffing relative to the hole in the matrix and release of steam also gives the texture of the product. The product is transferred to a drying furnace which is a direct combustion type and a hot air circulation towards the product moving on a network for a specified time and our temperature is 140-170 degrees. After the drying of the product, the system moves to a rotating tuff system and oil spraying systems and flavoring agent on the hot product after cooling. The product is packed in huge bags to reach the room temperature. It is transferred to the packaging. This process is our product on a single screw extruder.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. An extruded ready to consume food product comprising: corn and at least one of grain and dry edible mushroom.

2. An extruded ready to consume food product according to claim 1, said food product comprising corn, grain and dry edible mushroom.

3. An extruded ready to consume food product according to claim 1, wherein said grain is selected from legume, oats, cereal grain, pseudo-grain, pulses, oilseed and any combinations thereof.

4. An extruded ready to consume food product according to claim 1, wherein said grain is oats.

5. An extruded ready to consume food product according to claim 1, wherein said grain is legume.

6. An extruded ready to consume food product according to claim 1, comprising oats.

7. An extruded ready to consume food product according to claim 1, comprising dry edible mushroom.

8. An extruded ready to consume food product according to claim 1, wherein said grain is at least 15% wt of the ready to consume food product.

9. An extruded ready to consume food product according to claim 1, wherein said dry edible mushroom is at least 10% wt of the ready to consume food product.

10. An extruded ready to consume food product according to claim 1, wherein said dry edible mushroom is selected from shiitake mushroom, champignon mushroom, porcini mushroom, black trumpet mushroom, morel mushroom, matsutake mushroom, maiitake mushroom, chanterelle mushroom, turkey tail mushroom, lion's mane mushroom, Agricusl blazei murrill mushroom, lobster mushroom, oyster mushroom, king oyster mushroom, truffle and any combinations thereof.

11. An extruded ready to consume food product according to claim 1, further comprising starch.

12. An extruded ready to consume food product according to claim 1, further comprising at least one flavoring agent.

13. An extruded ready to consume food product according to claim 1, wherein corn is no more than 90% wt of the ready to consume food product.

14. An extruded ready to consume food product according to claim 1, wherein corn is no more than 80% wt of the ready to consume food product.

15. An extruded ready to consume food product according to claim 1, wherein corn is no more than 60% wt of the ready to consume food product.

16. An extruded ready to consume food product according to claim 1, wherein corn is no more than 20% wt of the ready to consume food product.

17. An extruded ready to consume food product according to claim 1, wherein corn is no more than 10% wt of the ready to consume food product.

18. An extruded ready to consume food product according to claim 1, wherein corn is between about 10% to 90% wt of the ready to consume food product

19. An extruded ready to consume food product according to claim 1, further comprising starch, wherein starch is no more than 4% wt of the ready to consume food product.

20. An extruded ready to consume food product according to claim 1, further comprising starch, wherein starch is between 1% to 4% wt of the ready to consume food product.
